(19) United States
(12) Patent Application Publication
(10) Pub. No.: US 2026/0351055 A1
(43) Pub. Date: Nov. 5, 2026

(54) DETECTING NOISE AND VIBRATION POLLUTION USING VEHICLE SENSORS AND RADIO-FREQUENCY IDENTIFICATION TECHNOLOGY

(71) Applicant: International Business Machines Corporation, Armonk, NY (US)

(72) Inventors: Cristina BONANNI, Rome (IT); Martina VERRELLI, Rome (IT); Stefano BRAGHIN, Dublin (IE); Luigi PICHETTI, Rome (IT); Martina BERNARDINI, Cadoneghe (IT)

(21) Appl. No.: 19/198,603

(22) Filed: May 5, 2025

(51) Int. Cl. G07C 5/00; G01M 17/007; G07C 5/08

(52) U.S. Cl. CPC G07C 5/008; G01M 17/007; G07C 5/006; G07C 5/0816

(57) ABSTRACT

A computer system may receive, from a plurality of vehicle sensors of a plurality of vehicles, sensor data identifying noise and vibration emissions that exceed a threshold, and may receive radio-frequency identification (RFID) data associated with the plurality of vehicles. The computer system may retrieve vehicle data associated with the plurality of vehicles based on the RFID data, and may utilize a machine learning model to generate correlated data based on the sensor data, the RFID data, and the vehicle data and to identify a source vehicle of the noise and vibration emissions. The computer system may determine one or more causes of the noise and vibration emissions of the source vehicle based on the correlated data, the RFID data, and the vehicle data, and may output an alert notification identifying the source vehicle and the one or more causes of the noise and vibration emissions.

### BACKGROUND

This disclosure relates to noise and vibration pollution and, more specifically, to an adaptive system for detecting noise and vibration pollution using vehicle sensors and radio-frequency identification (RFID) technology.

### SUMMARY

Some aspects described herein relate to a method. The method may include receiving, from a plurality of vehicle sensors of a plurality of vehicles, sensor data identifying noise and vibration emissions that exceed a threshold, and receiving RFID data associated with the plurality of vehicles. The method may include retrieving vehicle data associated with the plurality of vehicles based on the RFID data, and utilizing a machine learning model to generate correlated data based on the sensor data, the RFID data, and the vehicle data and to identify a source vehicle of the noise and vibration emissions. The method may include determining one or more causes of the noise and vibration emissions of the source vehicle based on the correlated data, the RFID data, and the vehicle data, and outputting an alert notification identifying the source vehicle and the one or more causes of the noise and vibration emissions.

Some aspects described herein relate to a computer system. The computer system may include a processor set, one or more computer-readable storage media, and program instructions stored on the one or more computer-readable storage media to cause the processor set to perform operations. The operations may include receiving, from a plurality of vehicle sensors of a plurality of vehicles, sensor data identifying noise and vibration emissions that exceed a threshold, and receiving RFID data associated with the plurality of vehicles. The operations may include retrieving vehicle data associated with the plurality of vehicles based on the RFID data, and utilizing a machine learning model to generate correlated data based on the sensor data, the RFID data, and the vehicle data and to identify a source vehicle of the noise and vibration emissions. The operations may include determining one or more causes of the noise and vibration emissions of the source vehicle based on the correlated data, the RFID data, and the vehicle data, and utilizing a Markov chain analysis to determine a probability of the source vehicle being a source of the noise and vibration emissions. The operations may include determining whether the probability satisfies a probability threshold, and outputting an alert notification identifying the source vehicle and the one or more causes of the noise and vibration emissions based on determining that the probability satisfies the probability threshold.

Some aspects described herein relate to a computer program product. The computer program product may include one or more computer-readable storage media and program instructions stored on the one or more computer-readable storage media to perform operations. The operations may include receiving, from a plurality of vehicle sensors of a plurality of vehicles, sensor data identifying noise and vibration emissions that exceed a threshold, and receiving RFID data associated with the plurality of vehicles. The operations may include retrieving vehicle data associated with the plurality of vehicles based on the RFID data, and utilizing a machine learning model to generate correlated data based on the sensor data, the RFID data, and the vehicle data and to identify a source vehicle of the noise and vibration emissions. The operations may include determining one or more causes of the noise and vibration emissions of the source vehicle based on the correlated data, the RFID data, and the vehicle data, and utilizing a Markov chain analysis to determine a probability of the source vehicle being a source of the noise and vibration emissions. The operations may include determining whether the probability satisfies a probability threshold.

### BRIEF DESCRIPTION OF THE DRAWINGS

FIG. 1 is a diagram of an example computing environment for detecting noise and vibration pollution using vehicle sensors and RFID technology, as described herein.

FIGS. 2A-2F are diagrams of an example associated with detecting noise and vibration pollution using vehicle sensors and RFID technology, as described herein.

FIG. 3 is a diagram illustrating an example of training and using a machine learning model.

FIG. 4 is a flowchart of an example process associated with detecting noise and vibration pollution using vehicle sensors and RFID technology.

### DETAILED DESCRIPTION

The following detailed description of example implementations refers to the accompanying drawings. The same reference numbers in different drawings may identify the same or similar elements.

Monitoring and identifying noise and vibration pollution in urban areas is a significant challenge, particularly in areas without cameras or road sensors. Traditional methods of detecting noise pollution, such as using cameras and microphones, can lead to errors and inaccuracies. For example, cameras may not be able to identify an exact vehicle producing the noise, especially in areas with multiple vehicles. Furthermore, microphones may not be able to accurately pinpoint a source of noise. Relying on the use of cameras and microphones also requires significant infrastructure investments and may not be effective in all scenarios. Additionally, the traditional methods often rely on manual monitoring and enforcement, which can be resource-intensive and prone to errors. Thus, traditional methods for identifying noise and vibration pollution consume computing resources (e.g., processing resources, memory resources, communication resources, and/or the like), networking resources, and/or the like associated with failing to identify sources of noise and vibration pollution, utilizing inefficient and inaccurate cameras and microphones to identify sources of noise and vibration pollution, requiring infrastructure investment and manual monitoring of the camera and microphones, and/or the like.

Some implementations described herein provide a computer system for detecting noise and vibration pollution using vehicle sensors and RFID technology. For example, the computer system may receive, from a plurality of vehicle sensors of a plurality of vehicles, sensor data identifying noise and vibration emissions that exceed a threshold, and may receiving RFID data associated with the plurality of vehicles. The computer system may retrieve vehicle data associated with the plurality of vehicles based on the RFID data, and may utilize a machine learning model to generate correlated data based on the sensor data, the RFID data, and the vehicle data, and to identify a source vehicle of the noise and vibration emissions. The computer system may determine one or more causes of the noise and vibration emissions of the source vehicle based on the correlated data, the RFID data, and the vehicle data, and may output an alert notification identifying the source vehicle and the one or more causes of the noise and vibration emissions.

In this way, the computer system detects noise and vibration pollution using vehicle sensors and RFID technology. For example, the computer system may accurately and efficiently detect and identify noise and vibration pollution in real-time and in urban areas and areas without cameras or road sensors. The computer system may receive sensor data from a plurality of vehicle sensors of a plurality of vehicles, and RFID data and vehicle data associated with the plurality of vehicles. The computer system may utilize a machine learning model to generate correlated data based on the sensor data, the RFID data, and the vehicle data, and to identify a source vehicle that is generating the noise and vibration emissions. The computer system may determine one or more causes of the noise and vibration emissions by the source vehicle based on the correlated data, the RFID data, and the vehicle data. Thus, the computer system conserves computing resources, networking resources, and/or the like that would otherwise have been consumed by failing to identify sources of noise and vibration pollution, utilizing inefficient and inaccurate cameras and microphones to identify sources of noise and vibration pollution, requiring infrastructure investment and manual monitoring of the camera and microphones, and/or the like.

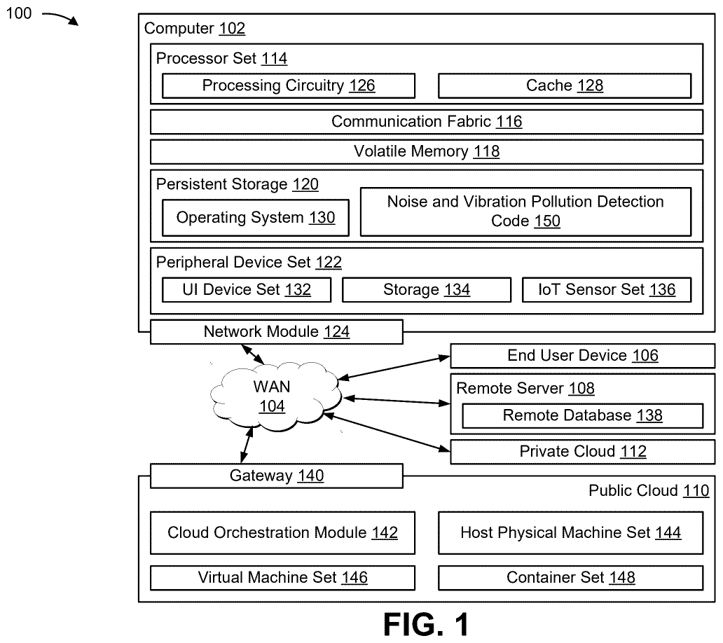

FIG. 1 is a diagram of an example computing environment 100 for detecting noise and vibration pollution using vehicle sensors and RFID technology, as described herein.

Computing environment 100 contains an example of an environment for the execution of at least some of the computer code involved in performing the inventive methods, such as noise and vibration pollution detection code 150. In addition to noise and vibration pollution detection code 150, computing environment 100 includes, for example, a computer 102, a wide area network (WAN) 104, an end user device (EUD) 106, a remote server 108, a public cloud 110, and a private cloud 112. In this embodiment, computer 102 includes a processor set 114 (including processing circuitry 126 and a cache 128), a communication fabric 116, a volatile memory 118, persistent storage 120 (including an operating system 130 and noise and vibration pollution detection code 150, as identified above), a peripheral device set 122 (including a user interface (UI) device set 132, storage 134, and an Internet of Things (IoT) sensor set 136), and a network module 124. Remote server 108 includes a remote database 138. Public cloud 110 includes a gateway 140, a cloud orchestration module 142, a host physical machine set 144, a virtual machine set 146, and a container set 148.

Computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 138. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 102, to keep the presentation as simple as possible. Computer 102 may be located in a cloud, even though it is not shown in a cloud in FIG. 1. On the other hand, computer 102 is not required to be in a cloud except to any extent as may be affirmatively indicated.

Processor set 114 includes one, or more, computer processors of any type now known or to be developed in the future. Processing circuitry 126 may be distributed over multiple packages (for example, multiple, coordinated integrated circuit chips). Processing circuitry 126 may implement multiple processor threads and/or multiple processor cores. Cache 128 is memory that is located in the processor chip package(s) and is typically used for data or code that should be available for rapid access by the threads or cores running on processor set 114. Cache memories are typically organized into multiple levels depending upon relative proximity to the processing circuitry. Alternatively, some, or all, of the cache for the processor set may be located “off chip.” In some computing environments, processor set 114 may be designed for working with qubits and performing quantum computing.

Computer-readable program instructions are typically loaded onto computer 102 to cause a series of operational steps to be performed by processor set 114 of computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 128 and the other storage media discussed below. The program instructions, and associated data, are accessed by processor set 114 to control and direct performance of the inventive methods. In computing environment 100, at least some of the instructions for performing the inventive methods may be stored in noise and vibration pollution detection code 150 in persistent storage 120.

Communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 118 is any type of volatile memory now known or to be developed in the future. Examples include dynamic type random access memory (RAM) or static type RAM. Typically, volatile memory 118 is characterized by random access, but this is not required unless affirmatively indicated. In computer 102, the volatile memory 118 is located in a single package and is internal to computer 102, but, alternatively or additionally, the volatile memory may be distributed over multiple packages and/or located externally with respect to computer 102.

Persistent storage 120 is any form of non-volatile storage for computers that is now known or to be developed in the future. The non-volatility of this storage means that the stored data is maintained regardless of whether power is being supplied to computer 102 and/or directly to persistent storage 120. Persistent storage 120 may be a read only memory (ROM), but typically at least a portion of the persistent storage allows writing of data, deletion of data, and re-writing of data. Some familiar forms of persistent storage include magnetic disks and solid-state storage devices. Operating system 130 may take any of several forms, such as various known proprietary operating systems or open source Portable Operating System Interface-type operating systems that employ a kernel.

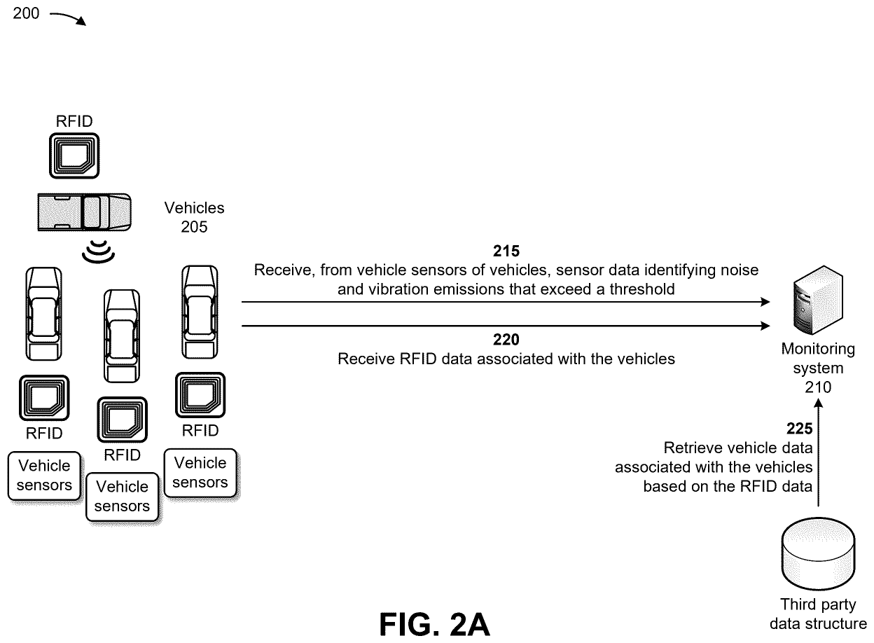

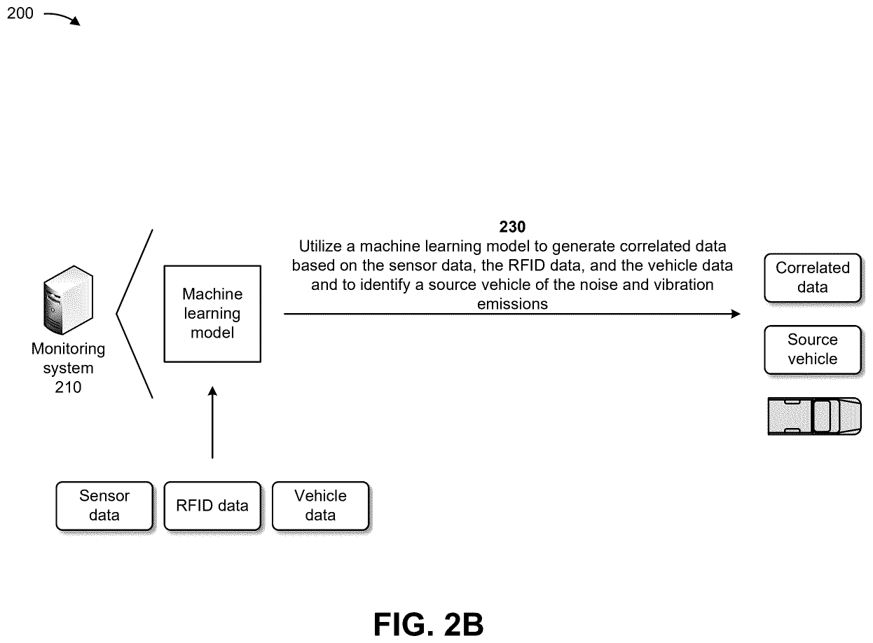

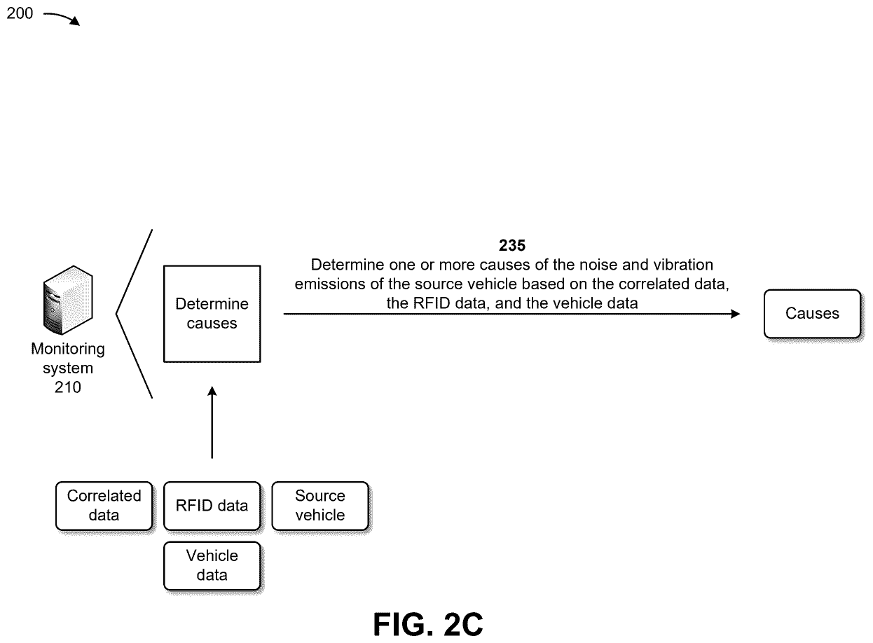

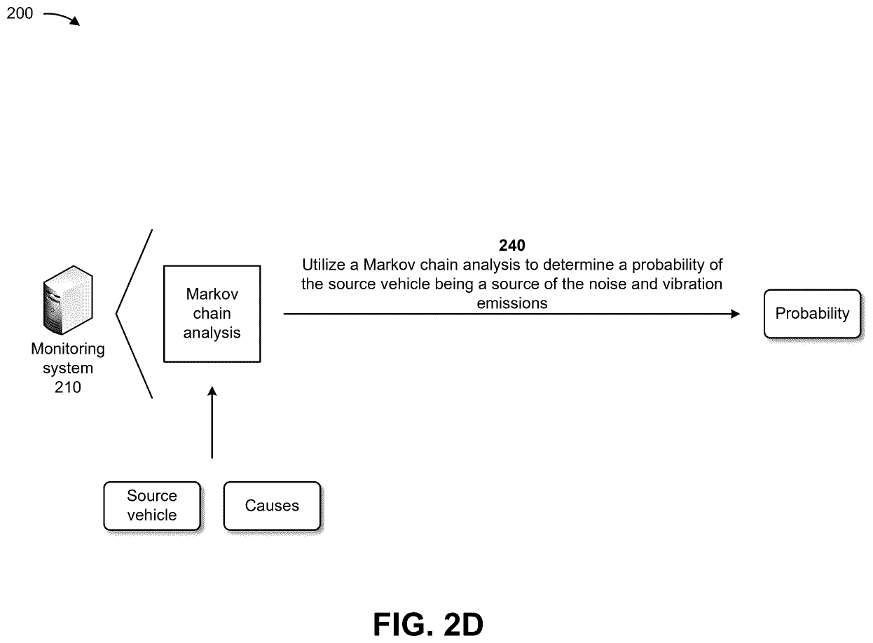

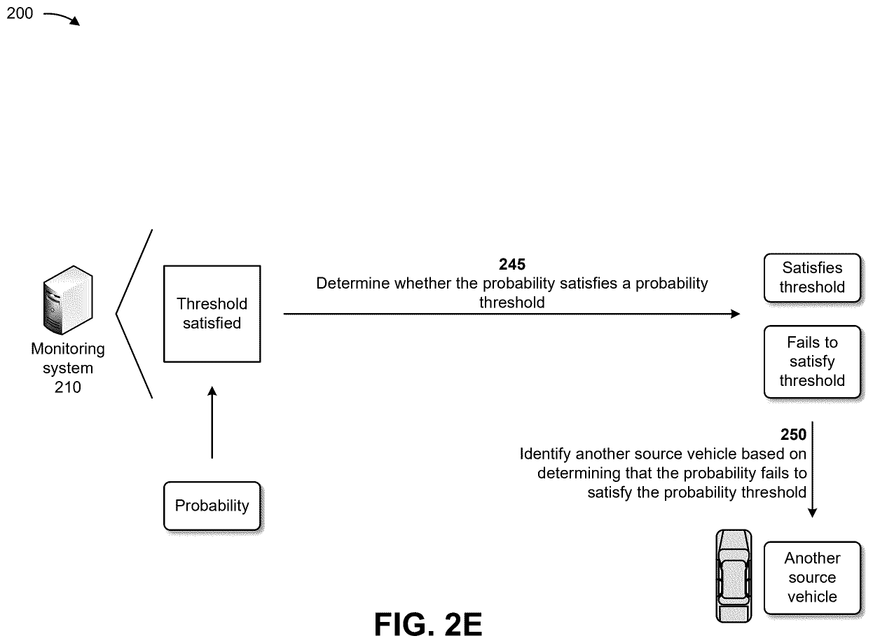

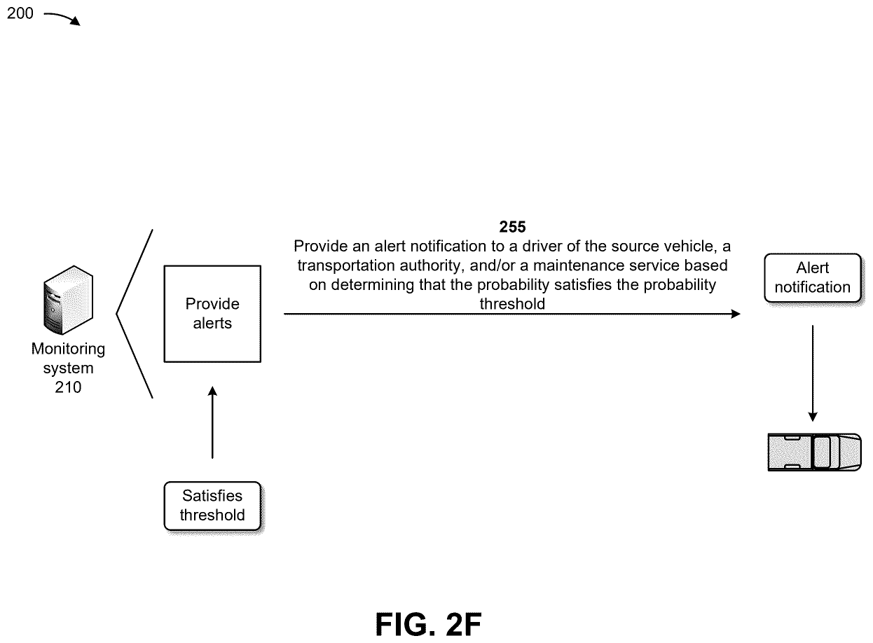

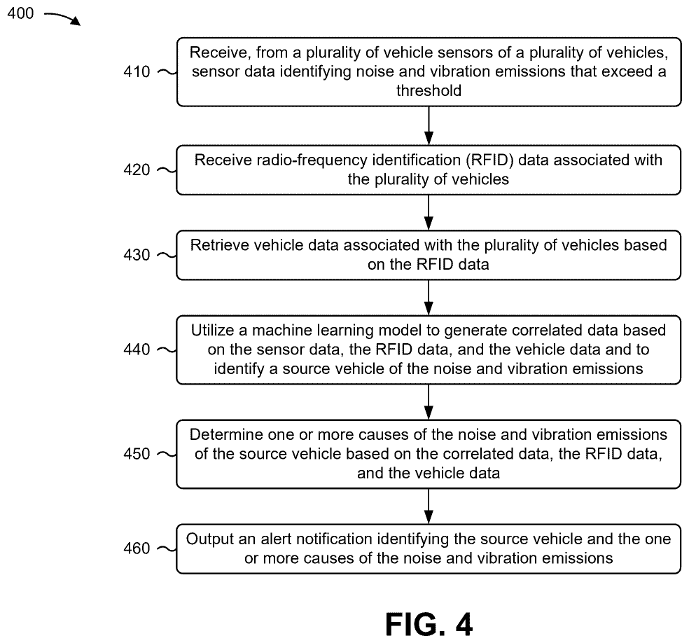

The code included in the noise and vibration pollution detection code 150 typically includes at least some of the computer code involved in performing one or more operations described herein, such as the operations of implementation 200 in FIGS. 2A-2F and the process described in FIG. 4.

Peripheral device set 122 includes the set of peripheral devices of computer 102. Data communication connections between the peripheral devices and the other components of computer 102 may be implemented in various ways, such as Bluetooth® connections, Near-Field Communication (NFC) connections, connections made by cables (such as universal serial bus (USB) type cables), insertion-type connections (for example, secure digital (SD) card), connections made through local area communication networks and/or connections made through wide area networks such as the internet. In various embodiments, UI device set 132 may include components such as a display screen, speaker, microphone, wearable devices (such as goggles and smart watches), keyboard, mouse, printer, touchpad, game controllers, and/or haptic devices. Storage 134 is external storage, such as an external hard drive, or insertable storage, such as an SD card. Storage 134 may be persistent and/or volatile. In some embodiments, storage 134 may take the form of a quantum computing storage device for storing data in the form of qubits. In embodiments where computer 102 is required to have a large amount of storage (for example, where computer 102 locally stores and manages a large database), this storage may be provided by peripheral storage devices designed for storing very large amounts of data, such as a storage area network (SAN) that is shared by multiple, geographically distributed computers. IoT sensor set 136 is made up of sensors that can be used in Internet of Things applications. For example, one sensor may be a thermometer and another sensor may be a motion detector.

Network module 124 is the collection of computer software, hardware, and firmware that allows computer 102 to communicate with other computers through WAN 104. Network module 124 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 124 are performed on the same physical hardware device. In other embodiments (for example, embodiments that utilize software-defined networking (SDN)), the control functions and the forwarding functions of network module 124 are performed on physically separate devices, such that the control functions manage several different network hardware devices. Computer-readable program instructions for performing the inventive methods can typically be downloaded to computer 102 from an external computer or external storage device through a network adapter card or network interface included in network module 124.

WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and/or edge servers.

EUD 106 is any computer system that is used and controlled by an end user (for example, a customer of an enterprise that operates computer 102), and may take any of the forms discussed above in connection with computer 102. EUD 106 typically receives helpful and useful data from the operations of computer 102. For example, in a hypothetical case where computer 102 is designed to provide a recommendation to an end user, this recommendation would typically be communicated from network module 124 of computer 102 through WAN 104 to EUD 106. In this way, EUD 106 can display, or otherwise present, the recommendation to an end user. In some embodiments, EUD 106 may be a client device, such as thin client, heavy client, mainframe computer, desktop computer and so on.

Remote server 108 is any computer system that serves at least some data and/or functionality to computer 102. Remote server 108 may be controlled and used by the same entity that operates computer 102. Remote server 108 represents the machine(s) that collect and store helpful and useful data for use by other computers, such as computer 102. For example, in a hypothetical case where computer 102 is designed and programmed to provide a recommendation based on historical data, this historical data may be provided to computer 102 from remote database 138 of remote server 108.

Public cloud 110 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 110 is performed by the computer hardware and/or software of cloud orchestration module 142. The computing resources provided by public cloud 110 are typically implemented by virtual computing environments that run on various computers making up the computers of host physical machine set 144, which is the universe of physical computers in and/or available to public cloud 110. The virtual computing environments (VCEs) typically take the form of virtual machines from virtual machine set 146 and/or containers from container set 148. These VCEs may be stored as images and may be transferred among and between the various physical machine hosts, either as images or after instantiation of the VCE. Cloud orchestration module 142 manages the transfer and storage of images, deploys new instantiations of VCEs, and manages active instantiations of VCE deployments. Gateway 140 is the collection of computer software, hardware, and firmware that allows public cloud 110 to communicate through WAN 104.

Some further explanation of VCEs will now be provided. VCEs can be stored as “images.” A new active instance of a VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 112 is similar to public cloud 110, except that the computing resources are only available for use by a single enterprise. While private cloud 112 is depicted as being in communication with WAN 104, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this example, public cloud 110 and private cloud 112 are both part of a larger hybrid cloud.

Cloud computing services and/or microservices (not separately shown in FIG. 1): private and public clouds 110 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where content is being presented to an internal or external customer in the form of a cloud computing service. As-a-service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with such tasks. Another category is Software-as-a-Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the computing environment 100 may perform one or more functions described as being performed by another set of devices of the computing environment 100.

FIGS. 2A-2F are diagrams of an example 200 associated with detecting noise and vibration pollution using vehicle sensors and RFID technology, as described herein. As shown in FIGS. 2A-2F, the example 200 includes vehicles 205 associated with RFID tags, vehicle sensors, and a monitoring system 210. The vehicles 205 may include onboard computers (e.g., vehicle control units (VCUs)) that correspond to the computer 102. An RFID tag is a small electronic device that uses radio frequency signals to transmit data wirelessly to an RFID reader for identification and tracking purposes. The vehicle sensors may include microphones, accelerometers, vibration sensors, inertial measurement units (IMUs), noise detection sensors, and/or the like. In some implementations, one or more RFID tags and/or one or more vehicle sensors may be associated with each of the vehicles 205. The monitoring system 210 may correspond to the computer 102, the end user device 106, the remote server 108, a system provided by the public cloud 110, and/or a system provided by the private cloud 112. Further details of the vehicles 205, the RFID tags, the vehicle sensors, and the monitoring system 210 are provided elsewhere herein.

As shown in FIG. 2A, and by reference number 215, the monitoring system 210 may receive, from the vehicle sensors of the vehicles 205, sensor data identifying noise and vibration emissions that exceed a threshold. For example, the vehicles 205 may include a variety of vehicle sensors that may capture the sensor data identifying noise and vibration emissions, such as microphones, accelerometers, vibration sensors, IMUs, noise detection sensors, and/or the like. The microphones may detect and measure sound pressure levels, which enables the microphones to capture noise emissions from the vehicles 205, such as exhaust noise, engine noise, or other sounds. The accelerometers may detect and measure vibrations, which enables the accelerometers to capture vibration emissions from the vehicles 205, such as vibration emissions caused by uneven road surfaces, engine imbalance, or other factors. The vibration sensors may detect and measure vibrations in specific frequency ranges, which enables the vibration sensors to capture vibration emissions from the vehicles 205, such as vibration emissions caused by engine mountings, suspension systems, or other components of the vehicles 205. The IMUs may detect and measure acceleration, roll, pitch, and yaw of the vehicles 205, which enables the IMUs to capture vibration emissions from the vehicles 205, such as vibration emissions caused by uneven road surfaces, engine imbalance, or other factors. The noise detection sensors may detect and measure noise levels, which enables the noise detection sensors to capture noise emissions from the vehicles 205, such as exhaust noise, engine noise, or other sounds.

In some implementations, the vehicles 205 and/or the vehicle sensors may determine whether the sensor data satisfies a threshold (e.g., a threshold that represents typical noise and vibration emissions of a vehicle 205 that is operating correctly). For example, to determine whether the sensor data satisfies the threshold, an onboard computer (e.g., a VCU) of each vehicle 205, or a dedicated sensor processing unit of each vehicle sensor, may preprocess the sensor data to remove any noise or irrelevant information, and may compare the preprocessed sensor data with a threshold value (e.g., which may be set based on regulatory requirements, manufacturer specifications, or other criteria). If the sensor data exceeds the threshold value, the onboard computer or the dedicated sensor processing unit may determine that the sensor data satisfies the threshold.

If the sensor data satisfies the threshold, the vehicles 205 may provide the sensor data to the monitoring system 210 using various communication protocols, such as via cellular networks, wireless local area networks (WLANs) (e.g., Wi-Fi or Bluetooth), dedicated short-range communications (DSRC) (e.g., a wireless communication technology specifically designed for vehicle-to-everything (V2X) communication), RFID technology (e.g., that utilizes radio waves to communicate between the RFID tags of the vehicles 205 and an RFID reader of the monitoring system 210), and/or the like. The vehicles 205 and/or the vehicle sensors may continually provide the sensor data to the monitoring system 210, may periodically provide the sensor data to the monitoring system 210, may provide the sensor data to the monitoring system 210 based on receiving requests from the monitoring system 210, and/or the like. The monitoring system 210 may receive the sensor data from the vehicles 205, the vehicle sensors, and/or the RFID tags.

As further shown in FIG. 2A, and by reference number 220, the monitoring system 210 may receive RFID data associated with the vehicles. For example, the RFID tags may be used to identify surrounding vehicles 205 and to correlate the sensor data detected by the vehicle sensors. An RFID tag may include an antenna and an RFID reader. An RFID tag may be placed on a vehicle 205 and the antenna may emit a unique identifier and the RFID data. The identifier and the RFID data may be detected by RFID readers of RFID tags installed on other vehicles 205. The RFID readers may capture the identifier and the RFID data and may utilize the identifier and the RFID data to identify the vehicle 205 and a location of the vehicle 205. The RFID data may include data related to the vehicles 205, such as unique identification numbers, makes, models, maintenance histories, components, locations, and/or the like associated with the vehicles 205. Once the RFID data is captured by the RFID tags, the RFID tags may communicate the RFID data to the monitoring system 210 through a wireless communication network. The network may be based on various communication protocols, such as Wi-Fi, Bluetooth, or cellular networks, and may ensure that the RFID data is transmitted efficiently and securely to the monitoring system 210. The monitoring system 210 may utilize the RFID data to identify and track the vehicles 205 in real-time.

In some implementations, the vehicles 205 may utilize various other sensor technologies beyond RFID tags. For example, a vehicle 205 may include cameras equipped with optical character recognition (OCR) capabilities that can identify license plates of other vehicles 205. The vehicles 205 may provide this additional sensor data to the monitoring system 210. The integration of multiple sensor types may enhance an ability of the monitoring system 210 to accurately detect and correlate noise pollution with specific vehicles 205.

As further shown in FIG. 2A, and by reference number 225, the monitoring system 210 may retrieve vehicle data associated with the vehicles based on the RFID data. For example, the monitoring system 210 may utilize the RFID data to generate queries that retrieve the vehicle data from a third-party data structure (e.g., a database, a table, a list, and/or the like). In some implementations, the third-party data structure may include a database (e.g., an institutional database, such as a department of motor vehicles database) or a cloud-based service that stores comprehensive vehicle data about the vehicles 205. The vehicle data retrieved from the third-part data structure may include registration data associated with the vehicles 205, maintenance records of the vehicles 205, driver data associated with the vehicles 205, and/or the like. For example, the vehicle registration data of a vehicle 205 may include the vehicle registration number, an owner's name, an owner's address, vehicle insurance data, a registration expiry date, and/or the like. The maintenance data of a vehicle 205 may include records of past maintenance activities (e.g., oil changes, tire rotations, brake replacements, and/or the like), dates of service, details of repairs or replacements, information about maintenance service providers, and/or the like. The driver data associated with a vehicle 205 may include a driver's name, a driver's license number, a driving history, any reported incidents or violations, and/or the like.

As shown in FIG. 2B, and by reference number 230, the monitoring system 210 may utilize a machine learning model to generate correlated data based on the sensor data, the RFID data, and the vehicle data and to identify, from the vehicles 205, a source vehicle of the noise and vibration emissions. For example, the monitoring system 210 may preprocess the sensor data, the RFID data, and the vehicle data to prepare the data for machine learning model training. The preprocessing of the data may include cleaning and filtering the data to remove any irrelevant or erroneous information, normalizing the data to ensure that the data is in a suitable format for processing, transforming the data into a format that can be used by the machine learning model, and/or the like. The monitoring system 210 may extract relevant features from the preprocessed data to create a set of input features for the machine learning model. The features may include sensor data features, such as sound pressure levels, vibration frequencies, or temperature readings; RFID data features, such as vehicle identification numbers, location data, or timestamp information; vehicle data features, such as vehicle type, maintenance history, or driver behavior data.

The monitoring system 210 may utilize a suitable machine learning model to generate the correlated data and to identify the source vehicle from the vehicles 205. The machine learning model may include a supervised learning model (e.g., a linear regression model, a decision tree model, a random forest model, and/or the like), an unsupervised learning model (e.g., a k-means clustering model, a principal component analysis (PCA) model, and/or the like), or a deep learning model (e.g., a convolutional neural network (CNN) model, a recurrent neural network (RNN) model, and/or the like). In some implementations, the monitoring system 210 may train the machine learning model using the preprocessed data and feature engineering techniques. The machine learning model may learn to identify patterns and relationships between input features and a target variable (e.g., the source vehicle). The monitoring system 210 may utilize the machine learning model to generate the correlated data and to identify, from the vehicles 205, the source vehicle of the noise and vibration emissions.

As shown in FIG. 2C, and by reference number 235, the monitoring system 210 may determine one or more causes of the noise and vibration emissions of the source vehicle based on the correlated data, the RFID data, and the vehicle data. For example, the monitoring system 210 may analyze the correlated data, the RFID data, and the vehicle data, and may determine the one or more causes of the noise and vibration emissions of the source vehicle based on analyzing the data. For example, if the source vehicle is emitting excessive noise, the monitoring system 210 may analyze the RFID data to determine whether the source vehicle has an old muffler, inappropriate tires for the season and environment, and/or the like. The monitoring system 210 may also detect other causes of the noise and vibration emissions of the source vehicle, such as faulty engine components, worn-out brake pads, and/or the like.

In some implementations, the monitoring system 210 may extract relevant features from the correlated data, the RFID data, and the vehicle data, such as a vehicle identification number (VIN) of the source vehicle, a make and a model of the source vehicle, an age and mileage of the source vehicle, a maintenance history (e.g., last oil change, tire rotation, and/or the like) of the source vehicle, driving habits of a driver of the source vehicle (e.g., an average speed, an acceleration, and/or the like), and/or the like. The monitoring system 210 may utilize pattern recognition techniques to identify the one or more causes of the noise and vibration emissions from the extracted features. This may include the monitoring system 210 analyzing the sensor data of the source vehicle to identify unusual patterns or anomalies, comparing vehicle data of the source vehicle data with vehicle data of similar vehicles 205, identifying correlations between the sensor data and vehicle characteristics (e.g., age, mileage, and/or the like), and/or the like.

Alternatively, or additionally, the monitoring system 210 may apply a machine learning model to the correlated data, the RFID data, and the vehicle data to determine the one or more causes of the noise and vibration emissions of the source vehicle. This may include the monitoring system 210 utilizing a decision tree model or a rule-based model to evaluate the extracted features and the patterns, applying a Bayesian inference model or other statistical models to quantify a likelihood of each potential cause, and/or the like.

Alternatively, or additionally, the monitoring system 210 may utilize a knowledge-based system to determine the one or more causes of the noise and vibration emissions of the source vehicle. A knowledge-based system may utilize a knowledge base, which is a database of expert knowledge, to reason and make decisions. The knowledge-based system may include rules, decision trees, or other knowledge representations to identify the one or more causes of the noise and vibration emissions. Alternatively, or additionally, the monitoring system 210 may perform statistical analysis on the correlated data, the RFID data, and the vehicle data to identify trends, correlations, and patterns. This may include the monitoring system 210 utilizing a regression analysis, a principal component analysis, or a cluster analysis to identify relationships between variables and to determine the one or more causes of the noise and vibration emissions of the source vehicle. In some implementations, the monitoring system 210 may output the one or more causes as a ranked list of potential causes of the noise and vibration emissions, along with confidence levels or probability estimates for each cause.

As shown in FIG. 2D, and by reference number 240, the monitoring system 210 may utilize a Markov chain model to determine a probability of the source vehicle being a source of the noise and vibration emissions. For example, the monitoring system 210 may apply a Markov chain analysis to the correlated data to identify patterns and trends in the noise and vibration emissions identified in the sensor data. The Markov chain model may be trained on the correlated data and used to predict a likelihood of a vehicle 205 being a source of noise and vibration emissions based on a location of the vehicle 205, a speed of the vehicle 205, and other factors. In some implementations, the monitoring system 210 may utilize various techniques, such as a Metropolis-Hastings model or a Gibbs sampler model, to estimate parameters for the Markov chain model. The Metropolis-Hastings model or the Gibbs sampler model may be trained on data associated with the source vehicle, such as the sensor data of the source vehicle, the RFID data, and/or the vehicle data of the source vehicle.

The Metropolis-Hastings model may include a Markov chain model used for generating a sequence of samples from a probability distribution. The Metropolis-Hastings model may select an initial value for a parameter of interest, and may propose a new value for the parameter using a proposal distribution. The Metropolis-Hastings model may calculate a probability of accepting the new value using the Metropolis-Hastings ratio, which is a function of a current value, the proposed value, and a target distribution. The Metropolis-Hastings model may accept or reject the proposed value based on the calculated probability, and may repeat the aforementioned steps until convergence. The Gibbs sampler model may include a Markov chain model used for generating a sequence of samples from a probability distribution. The Gibbs sampler model is a special case of the Metropolis-Hastings model.

The monitoring system 210 may utilize the Markov chain model to model the noise and vibration emissions of the source vehicle as a random process. States of the Markov chain model may represent the possible sources of noise and vibration emissions. For example, the states may include: a first state (e.g., the source vehicle is the primary source of noise and vibration emissions), a second state (e.g., the source vehicle is not the primary source of noise and vibration emissions), and a third state (e.g., the source vehicle is one of multiple sources of noise and vibration emissions). Transition probabilities of the Markov chain model may represent probabilities of transitioning from one state to another state. Observation probabilities of the Markov chain model may represent probabilities of observing a particular sensor reading or RFID data given a particular state. The Markov chain model may utilize the transition probabilities to determine a next state based on a current state and the collected data, and may calculate the observation probabilities for each state based on the collected data. The Markov chain model may calculate a posterior probability distribution over the states using Bayes'Theorem and the observation probabilities, and may calculate the probability of the source vehicle being a source of the noise and vibration emissions based on the posterior probability distribution.

As shown by FIG. 2E, and reference number 245, the monitoring system 210 may determine whether the probability satisfies a probability threshold. For example, the monitoring system 210 may determine whether the probability satisfies a probability threshold by utilizing a fixed threshold or a dynamic threshold. The monitoring system 210 may determine a fixed threshold value based on various factors, such as the type of noise and vibration emissions, the location of the source vehicle, and/or the time of day. For example, the probability threshold may be set to 0.8, indicating that if the probability of the source vehicle being the source of the noise and vibration emissions is greater than or equal to 0.8, then the threshold is satisfied. The monitoring system 210 may utilize a dynamic threshold value that may be adjusted based on various factors, such as the type of noise and vibration emissions, the location of the source vehicle, and/or the time of day. For example, the monitoring system 210 may adjust the probability threshold based on the time of day, with a higher threshold during peak traffic hours and a lower threshold during off-peak traffic hours. In some implementations, the monitoring system 210 may determine that the probability satisfies the probability threshold. Alternatively, the monitoring system 210 may determine that the probability fails to satisfy the probability threshold.

As further shown in FIG. 2E, and by reference number 250, the monitoring system 210 may identify another source vehicle based on determining that the probability fails to satisfy the probability threshold. For example, if the monitoring system 210 determines that the probability fails to satisfy the probability threshold, the monitoring system 210 may utilize the machine learning model to identify the other source vehicle of the noise and vibration emissions, and to determine one or more causes of the noise and vibration emissions of the other source vehicle. The monitoring system 210 may utilize the Markov chain analysis to determine another probability of the other source vehicle being a source of the noise and vibration emissions, and may determine whether the other probability satisfies the probability threshold. The monitoring system 210 may continue to identify source vehicles until a probability of the source vehicle being a source of the noise and vibration emissions satisfies the probability threshold.

As shown by FIG. 2F, and reference number 255, the monitoring system 210 may provide an alert notification to a driver of the source vehicle, a transportation authority, and/or a maintenance service based on determining that the probability satisfies the probability threshold. For example, if the monitoring system 210 determines that the probability satisfies the probability threshold, the monitoring system 210 may generate the alert notification, and may provide the alert notification to the driver of the source vehicle (e.g., via the source vehicle or a user device associated with the driver), the transportation authority, and/or the maintenance service.

The alert notification provided by the monitoring system 210 can include a variety of information to help the recipient (e.g., the driver of the source vehicle, the transportation authority, or the maintenance service) understand the noise and vibration emissions issue and take appropriate action. For example, the alert notification may include source vehicle information (e.g., a VIN, a vehicle make and model, a vehicle license plate number, vehicle owner's name and contact information, and/or the like); noise and vibration emissions details (e.g., a type of noise and vibration emissions, a level of noise and vibration emissions, a location of the noise and vibration emissions, a time and date of the noise and vibration emissions, and/or the like); causes of the noise and vibration emissions (e.g., identification of the specific causes of the noise and vibration emissions and an explanation of how the causes are determined); recommended actions (e.g., instructions on how to address the noise and vibration emissions and recommendations for reducing noise and vibration emissions); consequences of inaction (e.g., a warning of potential consequences if the noise and vibration emissions are not addressed and an explanation of how the noise and vibration emissions can impact the environment, public health, and safety); an alert severity level (e.g., an indication of the severity level of the noise and vibration emissions and an explanation of the severity level and the corresponding recommended actions); an alert type (e.g., an identification of the type of alert and an explanation of the alert type and the corresponding recommended actions); and/or the like.

The monitoring system 210 may provide the alert notification in various formats, such as a text message (e.g., a text message that includes a brief summary of the noise and vibration emissions issue and recommended actions); an email notification providing more comprehensive information on the noise and vibration emissions issue; an in-vehicle notification (e.g., a notification displayed on the vehicle's dashboard or infotainment system); a mobile application notification (e.g., that allows the recipient to access more detailed information and take actions to address the noise and vibration emissions issue); a voice call providing a verbal notification of the noise and vibration emissions issue and recommended actions; a dedicated communication channel established with the transportation authority or the maintenance service; an automated notification system established with the transportation authority or the maintenance service; a web-based portal for the transportation authority or the maintenance system; integration with existing systems (e.g., traffic management systems or environmental monitoring systems); and/or the like.

In some implementations, the onboard computers of the vehicles 205 may include code (e.g., noise pollution agent code) that causes the onboard computers to receive the sensor data, the RFID data, and the vehicle data, to utilize the machine learning model to generate the correlated data based on the sensor data, the RFID data, and the vehicle data, and to forward the correlated data to the monitoring system 210. In some implementations, the monitoring system 210 may include code (e.g., the noise and vibration pollution detection code 150 or noise pollution service code) that causes the monitoring system 210 to utilize the machine learning model to generate the correlated data based on the sensor data, the RFID data, and the vehicle data and to identify, from the vehicles 205, the source vehicle of the noise and vibration emissions; to determine the one or more causes of the noise and vibration emissions of the source vehicle; to utilize the Markov chain analysis to determine the probability of the source vehicle being a source of the noise and vibration emissions; to determine whether the probability satisfies the probability threshold; and to provide the alert notification to the driver of the source vehicle, the transportation authority, and/or the maintenance service. In some implementations, the onboard computers of the vehicles 205 may perform one or more functions described as being performed by the monitoring system 210, and the monitoring system 210 may perform one or more functions described as being performed by the onboard computers of the vehicles 205.

In some implementations, the monitoring system 210 may handle scenarios involving multiple vehicles, both parked and in transit, to accurately identify, from the vehicles 205, the source vehicle of noise and vibration emissions. For example, consider a scenario where three vehicles (e.g., A, B, and C) are present in a specific area. Vehicle C is parked, while vehicles A and B are in transit. Traditional methods, such as using static cameras and microphones, may struggle to accurately identify which vehicle is producing the noise, especially in a busy area with multiple vehicles. However, with implementations described herein, the vehicle sensors in each vehicle may detect noise and vibration emissions, and the RFID tags may provide dynamic information about each vehicle. The monitoring system 210 may correlate the data detected by the sensors of the multiple vehicles, may compare the timing and intensity of the emissions, and may accurately identify the source vehicle. This may leverage the collaborative detection capabilities of multiple vehicles to triangulate the noise source and improve accuracy.

In this way, the monitoring system 210 detects noise and vibration pollution using vehicle sensors and RFID technology. For example, the monitoring system 210 may accurately and efficiently detect and identify noise and vibration pollution in real-time and in urban areas and areas without cameras or road sensors. The monitoring system 210 may receive sensor data from a plurality of vehicle sensors of a plurality of vehicles 205, and RFID data and vehicle data associated with the plurality of vehicles 205. The monitoring system 210 may utilize a machine learning model to generate correlated data based on the sensor data, the RFID data, and the vehicle data, and to identify a source vehicle that is generating the noise and vibration emissions. The monitoring system 210 may determine one or more causes of the noise and vibration emissions by the source vehicle based on the correlated data, the RFID data, and the vehicle data. Thus, the monitoring system 210 conserves computing resources, networking resources, and/or the like that would otherwise have been consumed by failing to identify sources of noise and vibration pollution, utilizing inefficient and inaccurate cameras and microphones to identify sources of noise and vibration pollution, requiring infrastructure investment and manual monitoring of the camera and microphones, and/or the like.

As indicated above, FIGS. 2A-2F are provided as an example. Other examples may differ from what is described with regard to FIGS. 2A-2F. The number and arrangement of devices shown in FIGS. 2A-2F are provided as an example. In practice, there may be additional devices, fewer devices, different devices, or differently arranged devices than those shown in FIGS. 2A-2F. Furthermore, two or more devices shown in FIGS. 2A-2F may be implemented within a single device, or a single device shown in FIGS. 2A-2F may be implemented as multiple, distributed devices. Additionally, or alternatively, a set of devices (e.g., one or more devices) shown in FIGS. 2A-2F may perform one or more functions described as being performed by another set of devices shown in FIGS. 2A-2F.

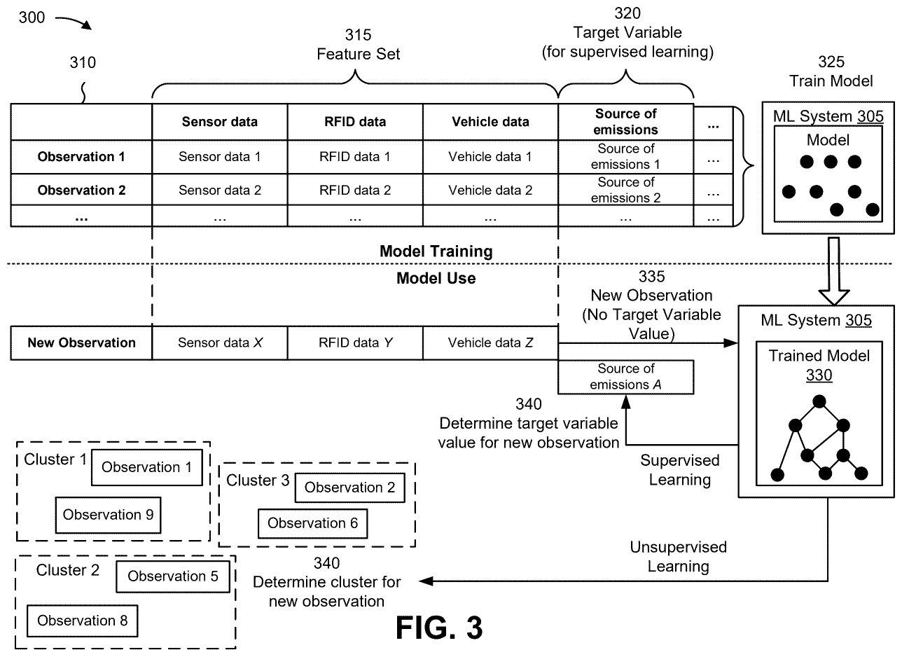

FIG. 3 is a diagram illustrating an example 300 of training and using a machine learning model. The machine learning model training and usage described herein may be performed using a machine learning system 305. The machine learning system may include or may be included in a computing device, a server, a cloud computing environment, and/or the like, such as the monitoring system 210 described in more detail elsewhere herein.

As shown by reference number 325, a machine learning model may be trained using a set of observations 310. The set of observations may be obtained from historical data, such as data gathered during one or more processes described herein. In some implementations, the machine learning system may receive the set of observations (e.g., as input) from the monitoring system 210, as described elsewhere herein.

The set of observations includes a feature set 315. The feature set 315 may include a set of variables, and a variable is also referred to as a feature herein. A specific observation may include a set of variable values (or feature values) corresponding to the set of variables. In some implementations, the machine learning system 305 may determine variables for a set of observations 310 and/or variable values for a specific observation based on input received from the monitoring system 210. For example, the machine learning system 305 may identify a feature set 315 (e.g., one or more features and/or feature values) by extracting the feature set 315 from structured data, by performing natural language processing to extract the feature set from unstructured data, by receiving input from an operator, and/or the like.

As an example, the feature set 315 for the set of observations 310 may include a first feature of sensor data, a second feature of RFID data, a third feature of vehicle data, and so on. As shown in FIG. 3, for a first observation, the first feature may have a value of sensory data 1, the second feature may have a value of RFID data 1, the third feature may have a value of vehicle data 1, and so on. These features and feature values are provided as examples and may differ in other examples.

The set of observations may be associated with a target variable 320. The target variable 320 may represent a variable having a numeric value, a variable having a numeric value that falls within a range of values or has some discrete possible values, a variable that is selectable from one of multiple options (e.g., one of multiple classes, classifications, labels, and/or the like), a variable having a Boolean value, and/or the like. A target variable 320 may be associated with a target variable value, and a target variable value may be specific to an observation. In example 300, the target variable 320 is “source of emissions” and may include a value of source of emissions 1 for the first observation.

The target variable 320 may represent a value that a machine learning model is being trained to predict, and the feature set may represent the variables that are input to a trained machine learning model to predict a value for the target variable. The set of observations 310 may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 325, the machine learning system 305 may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system 305 may store the machine learning model as a trained machine learning model 330 to be used to analyze new observations.

The machine learning system may apply the trained machine learning model 330 to a new observation, such as by receiving a new observation, as shown by reference number 335, and inputting the new observation to the trained machine learning model 330. As shown, the new observation may include a first feature of sensory data X, a second feature of RFID data Y, a third feature of vehicle data Z, and so on, as an example. The machine learning system 305 may apply the trained machine learning model 330 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 330 may predict a value of source of emissions A for the target variable of the source of emissions for the new observation, as shown by reference number 340. Based on this prediction, the machine learning system 305 may provide a first recommendation, may provide output for determination of a first recommendation, may perform a first automated action, may cause a first automated action to be performed (e.g., by instructing another device to perform the automated action), and/or the like.

In some implementations, the trained machine learning model 330 may classify (e.g., cluster) the new observation in a cluster, as shown by reference number 340. The observations within a cluster may have a threshold degree of similarity. As an example, if the machine learning system classifies the new observation in a first cluster (e.g., a sensor data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system 305 were to classify the new observation in a second cluster (e.g., an RFID data cluster), then the machine learning system 305 may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system 305 may apply a rigorous and automated process to determine a source of noise and vibration emissions. The machine learning system enables recognition and/or identification of tens, hundreds, thousands, or millions of features and/or feature values for tens, hundreds, thousands, or millions of observations, thereby increasing accuracy and consistency and reducing delay associated with determining a source of noise and vibration emissions relative to requiring computing resources to be allocated for tens, hundreds, or thousands of operators to manually determine a source of noise and vibration emissions.

As indicated above, FIG. 3 is provided as an example. Other examples may differ from what is described in connection with FIG. 3.

FIG. 4 is a flowchart of an example process 400 associated with detecting noise and vibration pollution using vehicle sensors and RFID technology. One or more process blocks of FIG. 4 are performed by a computer system (e.g., computer 102 and/or monitoring system 210) and/or by another device or a group of devices separate from or including the computer system. Additionally, or alternatively, one or more process blocks of FIG. 4 may be performed by one or more components of computer 102, such as processor set 114, communication fabric 116, volatile memory 118, and/or noise and vibration pollution detection code 150.

As shown in FIG. 4, process 400 may include receiving, from a plurality of vehicle sensors of a plurality of vehicles, sensor data identifying noise and vibration emissions that exceed a threshold (block 410). For example, the computer system may receive, from a plurality of vehicle sensors of a plurality of vehicles, sensor data identifying noise and vibration emissions that exceed a threshold, as described above. In some implementations, each of the plurality of vehicle sensors is installed in a respective vehicle of the plurality of vehicles. In some implementations, each of the plurality of vehicle sensors detects the noise and vibration emissions in a surrounding area of a respective vehicle of the plurality of vehicles.

As further shown in FIG. 4, process 400 may include receiving RFID data associated with the plurality of vehicles (block 420). For example, the computer system may receive RFID data associated with the plurality of vehicles, as described above. In some implementations, the RFID data is generated by a plurality of RFID tags attached to the plurality of vehicles. In some implementations, the RFID data includes data associated with maintenance histories or vehicle components of the plurality of vehicles.

As further shown in FIG. 4, process 400 may include retrieving vehicle data associated with the plurality of vehicles based on the RFID data (block 430). For example, the computer system may retrieve vehicle data associated with the plurality of vehicles based on the RFID data, as described above.

As further shown in FIG. 4, process 400 may include utilizing a machine learning model to generate correlated data based on the sensor data, the RFID data, and the vehicle data and to identify a source vehicle of the noise and vibration emissions (block 440). For example, the computer system may utilize a machine learning model to generate correlated data based on the sensor data, the RFID data, and the vehicle data and to identify a source vehicle of the noise and vibration emissions, as described above. In some implementations, the utilizing the machine learning model to generate the correlated data and to identify the source vehicle includes utilizing the machine learning model to analyze the sensor data to identify a pattern of noise and vibration emissions indicative of the source vehicle. In some implementations, the source vehicle is not included in the plurality of vehicles.

As further shown in FIG. 4, process 400 may include determining one or more causes of the noise and vibration emissions of the source vehicle based on the correlated data, the RFID data, and the vehicle data (block 450). For example, the computer system may determine one or more causes of the noise and vibration emissions of the source vehicle based on the correlated data, the RFID data, and the vehicle data, as described above.

As further shown in FIG. 4, process 400 may include outputting an alert notification identifying the source vehicle and the one or more causes of the noise and vibration emissions (block 460). For example, the computer system may output an alert notification identifying the source vehicle and the one or more causes of the noise and vibration emissions, as described above.

In some implementations, process 400 includes utilizing a Markov chain analysis to determine the probability of the source vehicle being a source of the noise and vibration emissions, and determining whether the probability satisfies a probability threshold. In some implementations, process 400 includes identifying another source vehicle based on determining that the probability fails to satisfy the probability threshold. In some implementations, process 400 includes providing the alert notification to a driver of the source vehicle based on determining that the probability satisfies the probability threshold. In some implementations, process 400 includes providing the alert notification to a transportation authority based on determining that the probability satisfies the probability threshold. In some implementations, process 400 includes providing the alert notification to a maintenance service based on determining that the probability satisfies the probability threshold.

In some implementations, utilizing the Markov chain analysis to determine the probability of the source vehicle being a source of the noise and vibration emissions includes utilizing the Markov chain analysis to estimate parameters of a statistical model using a Metropolis-Hastings model or a Gibbs sampler, and determining the probability based on the parameters of the statistical model.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations. For example, various implementations of this disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A computer program product embodiment (“CPP embodiment” or “CPP”) is a term used in this disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, RAM, ROM, erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in this disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, from a plurality of vehicle sensors of a plurality of vehicles, sensor data identifying noise and vibration emissions that exceed a threshold;
receiving radio-frequency identification (RFID) data associated with the plurality of vehicles;
retrieving vehicle data associated with the plurality of vehicles based on the RFID data;
utilizing a machine learning model to generate correlated data based on the sensor data, the RFID data, and the vehicle data and to identify a source vehicle of the noise and vibration emissions;
determining one or more causes of the noise and vibration emissions of the source vehicle based on the correlated data, the RFID data, and the vehicle data; and
outputting an alert notification identifying the source vehicle and the one or more causes of the noise and vibration emissions.

2. The method of claim 1, further comprising:
utilizing a Markov chain analysis to determine a probability of the source vehicle being a source of the noise and vibration emissions; and
determining whether the probability satisfies a probability threshold.

3. The method of claim 2, further comprising:
identifying another source vehicle based on determining that the probability fails to satisfy the probability threshold.

4. The method of claim 2, further comprising:
providing the alert notification to a driver of the source vehicle based on determining that the probability satisfies the probability threshold.

5. The method of claim 2, further comprising:
providing the alert notification to a transportation authority based on determining that the probability satisfies the probability threshold.

6. The method of claim 2, further comprising:
providing the alert notification to a maintenance service based on determining that the probability satisfies the probability threshold.

7. The method of claim 2, wherein utilizing the Markov chain analysis to determine the probability of the source vehicle being a source of the noise and vibration emissions comprises:
utilizing the Markov chain analysis to estimate parameters of a statistical model using a Metropolis-Hastings model or a Gibbs sampler; and
determining the probability based on the parameters of the statistical model.

8. A computer system, comprising:
a processor set;
one or more computer-readable storage media; and
program instructions stored on the one or more computer-readable storage media to cause the processor set to perform operations comprising:
receiving, from a plurality of vehicle sensors of a plurality of vehicles, sensor data identifying noise and vibration emissions that exceed a threshold;
receiving radio-frequency identification (RFID) data associated with the plurality of vehicles;
retrieving vehicle data associated with the plurality of vehicles based on the RFID data;
utilizing a machine learning model to generate correlated data based on the sensor data, the RFID data, and the vehicle data and to identify a source vehicle of the noise and vibration emissions;
determining one or more causes of the noise and vibration emissions of the source vehicle based on the correlated data, the RFID data, and the vehicle data;
utilizing a Markov chain analysis to determine a probability of the source vehicle being a source of the noise and vibration emissions;
determining whether the probability satisfies a probability threshold; and
outputting an alert notification identifying the source vehicle and the one or more causes of the noise and vibration emissions based on determining that the probability satisfies the probability threshold.

9. The computer system of claim 8, wherein each of the plurality of vehicle sensors is installed in a respective vehicle of the plurality of vehicles.

10. The computer system of claim 8, wherein each of the plurality of vehicle sensors detects the noise and vibration emissions in a surrounding area of a respective vehicle of the plurality of vehicles.

11. The computer system of claim 8, wherein the utilizing the machine learning model to generate the correlated data and to identify the source vehicle comprises:
utilizing the machine learning model to analyze the sensor data to identify a pattern of noise and vibration emissions indicative of the source vehicle.

12. The computer system of claim 8, wherein the RFID data is generated by a plurality of RFID tags attached to the plurality of vehicles.

13. The computer system of claim 8, wherein the RFID data includes data associated with maintenance histories or vehicle components of the plurality of vehicles.

14. The computer system of claim 8, wherein the source vehicle is not included in the plurality of vehicles.

15. A computer program product, comprising:
one or more computer-readable storage media; and
program instructions stored on the one or more computer-readable storage media to perform operations comprising:
receiving, from a plurality of vehicle sensors of a plurality of vehicles, sensor data identifying noise and vibration emissions that exceed a threshold;
receiving radio-frequency identification (RFID) data associated with the plurality of vehicles;
retrieving vehicle data associated with the plurality of vehicles based on the RFID data;
utilizing a machine learning model to generate correlated data based on the sensor data, the RFID data, and the vehicle data and to identify a source vehicle of the noise and vibration emissions;
determining one or more causes of the noise and vibration emissions of the source vehicle based on the correlated data, the RFID data, and the vehicle data;
utilizing a Markov chain analysis to determine a probability of the source vehicle being a source of the noise and vibration emissions; and
determining whether the probability satisfies a probability threshold.

16. The computer program product of claim 15, wherein the operations further comprise:
identifying another source vehicle based on determining that the probability fails to satisfy the probability threshold.

17. The computer program product of claim 15, wherein the operations further comprise:
providing, an alert notification, identifying the source vehicle and the one or more causes of the noise and vibration emissions, to a driver of the source vehicle based on determining that the probability satisfies the probability threshold.

18. The computer program product of claim 15, wherein the operations further comprise:
providing, an alert notification, identifying the source vehicle and the one or more causes of the noise and vibration emissions, to a transportation authority based on determining that the probability satisfies the probability threshold.

19. The computer program product of claim 15, wherein the operations further comprise:
providing, an alert notification, identifying the source vehicle and the one or more causes of the noise and vibration emissions, to a maintenance service based on determining that the probability satisfies the probability threshold.

20. The computer program product of claim 15, wherein utilizing the Markov chain analysis to determine the probability of the source vehicle being a source of the noise and vibration emissions comprises:
utilizing the Markov chain analysis to estimate parameters of a statistical model using a Metropolis-Hastings model or a Gibbs sampler; and
determining the probability based on the parameters of the statistical model.
